(19) United States
(12) Patent Application Publication
(10) Pub. No.: US 2001/0049745 A1
(43) Pub. Date: Dec. 6, 2001

(54) Method of enabling transmission and reception of communication when current destination for recipient is unknown to sender

(76) Inventor: Daniel Schoeffler, Huntington, NY (US)

Correspondence Address: BROWN PINNISI & MICHAELS, 400 M & T BANK BUILDING, 118 NORTH TIOGA ST, ITHACA, NY, 14850

(21) Appl. No.: 09/848,737

(22) Filed: May 3, 2001

Related U.S. Application Data
(60) Provisional application No. 60/201,605, filed on May 3, 2000.

(51) Int. Cl. G06F 15/173; G06F 15/16

(52) U.S. Cl. 709/238; 709/245; 709/206

(57) ABSTRACT

A method for forwarding of communications from a sender to a recipient through a separate forwarding server, using an address which is known or believed to be temporarily or permanently invalid to communicate with the recipient through a medium, including media other than that in which the address was formerly (but is not currently) valid. The invention enables and facilitates the transmission and reception of communications when the current destination of a communication to an intended recipient (e.g. street address, telephone number, e-mail address) is unknown to the sender, but a previous destination or other group or personal old address, now not currently active, is known. This method may be applied to electronic mail, telephony, postal mail, and other types of communications that require an addressed destination for the communication to be received.

### REFERENCE TO RELATED APPLICATIONS

This application claims an invention which was disclosed in Provisional Application No. 60/201,605, filed May 3, 2000, entitled “Communications Forwarding”. The benefit under 35 USC §119(e) of the U.S. provisional application is hereby claimed, and the aforementioned application is hereby incorporated herein by reference.

### BACKGROUND OF THE INVENTION

1. Field of the Invention

The invention pertains to the field of communications. More particularly, the invention pertains to methods of forwarding communications from a sender through a forwarding service to a recipient.

2. Description of Related Art

Today, many media are available for use in communications from one party to another. Generally, in order to facilitate the delivery of a communication to the intended recipient via any of these media, the communication is channeled to its destination via an addressing system. For example, in telephony, a specific handset (or set of connected handsets, facsimile machine, etc.) is identified by a telephone number. In addition, the caller may further identify the intended recipient of the call by asking for him by name. In electronic mail, a mailbox is identified by its e-mail address. If the address does not belong to a single person, the intended recipient may be further identified in the text of the communication. In postal mail, a destination is identified by a specific street address; the intended recipient may be more specifically defined by naming a particular party at that address.

In the context of this invention, it will be understood that language which normally relates to a particular communications medium, such as the words “address” and “send” in postal or electronic mail, is sometimes used more generally for other forms of communication, such as telephony. In addition, examples and features discussed with reference to one medium can generally be extended to other media.

If the linkage between an intended recipient and his destination address changes (e.g. if an addressee moves to a different street address or changes telephone numbers), the previous address is usually no longer valid for this addressee. While the address may no longer be valid for the intended recipient, the communication may still be forwarded by the communications provider (post office, telephone company) from the old address (or from an interception point on the way to the old address) to the new address.

This will be referred to herein as “direct forwarding”, in that so far as the original sender is concerned, the communication is still sent to the recipient's original address via the ordinary communications server, and the ordinary communications server redirects the communication to a different address to reach the recipient, usually without the knowledge or intervention of the sender. “Server” or “service” as used in this invention, is intended to encompass any mechanism of delivering a communication from one party to another, whether it be manual, automated or computerized, from the United States Postal Service or Federal Express, through telephone exchanges to computer e-mail or web servers, or other services as appropriate to the communication being forwarded. “Communication” or “message” is intended to encompass either the information content that the sender seeks to transfer to the recipient or the protocol to transfer the information content (or to establish that transfer), in any medium. It will also be understood that a sender may also be a recipient of messages in return, either as replies or in a bi-directional communications environment.

Provision is often made in various communications media for direct forwarding, generally for a limited period and at some cost to the user. If provision is not made, communications sent to that address are normally dropped or returned to the sender. As examples of direct forwarding in different media:

For postal mail forwarding, the Postal Service can intercept mail at the local Post Office before delivery and send it on to the intended recipient at the new address, provided the recipient has registered the new address for forwarding.

Similarly, for telephone call forwarding, the telephone company can switch a call to a user at a number other than the one dialed, provided the user has registered the new number, and provided the old number has not been reassigned (and, possibly, provided that the new number is served by the same telephone company or switching center as the old one). The telephone company may also announce the new number to callers but not transfer the call (this is not actually forwarding since the caller must redial the new number).

For electronic mail, the e-mail server software which handles e-mail for a given address (usually, this is one or more servers for a given domain) may be configured to direct forward a message to the intended recipient at another address. It may also be configured to mark the message “undeliverable” and “return” it to the sender, or it may discard the message without further action.

There are some e-mail systems which provide a service where a message may be sent to a server using an identifier other than the recipient's e-mail address, and the server will then forward to a registered e-mail address. An example of this is the service offered by the American Radio Relay League (ARRL), where a ham operator having the callsign WB2JWD can receive mail at wb2jwd@arrl.net, and the mail will be forwarded to an e-mail address he has currently registered at arrl.net. The identifier in this case (callsign) is not a known, but currently invalid, address for receiving mail, but rather an alias at the mail server.

These U.S. patents are related to the method of the invention:

U.S. Pat. No. 5,625,681—“Method and Apparatus for Telephone Number Portability”—this is an automated telephone lookup system in a translation database, to provide direct forwarding. It does not provide a central number for a server which can forward from a known bad phone number to a new number.

U.S. Pat. No. 5,742,769—“Directory with Options for Access to and Display of e-Mail Addresses”—is a lookup service to send electronic mail anonymously, without revealing the address of the recipient.

U.S. Pat. No. 5,812,776—“Method of Providing Internet Pages by Mapping Telephone Number Provided by Client to URL and Returning the Same in a Redirect Command by Server”—in this patent, a telephone number is used to retrieve web pages. The phone number (a current telephone number belonging to a merchant, for example) is mapped to a URL, and a web page is returned.

U.S. Pat. No. 5,832,061—“System and Method Incorporating a Mover's Mailbox in an Intelligent Network”—this patent is a method of direct forwarding, either to a new phone number or to a mailbox.

U.S. Pat. No. 5,937,161—“Electronic Message Forwarding System” is another direct-forwarding system, in the Internet message context, in which messages are forwarded by a “message queue agent” at the server based on user-defined addresses and message content.

U.S. Pat. No. 5,974,453—“Method and Apparatus for Translating a Static Identifier Including a Telephone Number Into a Dynamically Assigned Network Address” provides a DNS-like service for direct forwarding of messages to dynamically assigned IP addresses, as are used by transient users. The message sender uses a known good address, which is translated to the dynamic address by the server, not a known bad address after messages are returned.

U.S. Pat. No. 5,987,508—“Method of Providing Seamless Cross-Service Connectivity in Telecommunications Network”—This patent uses a known good telephone number as an address for e-mail, effectively as an alias for the true e-mail address. A sender sends e-mail to a mail translation server, using the phone number as the username. If the end recipient has registered with the server, then the e-mail is forwarded to his current e-mail address. If he has not, the server calls the telephone number and invites him to register. Thus, the method will only work if the alias identifier (telephone number) is currently valid.

U.S. Pat. No. 6,014,711—“Apparatus and Method for Providing Electronic Mail Relay Translation Services”—This system uses a translation server to accept voice-mail calls to a known good phone number, and forward them to an e-mail address, using a standard LDAP server for the translation.

U.S. Pat. No. 6,085,231—“Method and System for Delivering a Voice Message via an Alias e-Mail Address” is another system for forwarding voice mail messages left at a known good phone number to an e-mail subscriber.

U.S. Pat. No. 6,088,433—“System and Method for Forwarding Call from Disconnected Telephone Number to New Telephone Number”—this method involves the internals of a direct forwarding system, in that the telephone system itself recognizes that the phone number is bad, and forwards it to another server which forwards the call if the subscriber or the calling party has elected to pay for the service. The method is functional as long as the old telephone number is not reassigned.

U.S. Pat. No. 6,104,789—“Method and System for Transmitting Text Messages from a Caller to a Subscriber at an Unknown Address”—this system passes text-based messages to pagers or the like. The person calling calls one number, and enters information (such as a phone number) in response to prompts. The information is looked up in a directory, and a number of identifiers are retrieved. Then, a further prompt asks the person calling if they want to send messages in whatever formats the data represents—fax, phone, pager, voice mail, e-mail, etc. In essence, the system is a multimedia directory assistance and format translation system.

This invention is distinct from a directory of name/address pairs like a telephone book or e-mail directory. These require the disclosure of the new address to the sender of the communication and do not handle the forwarding operation. The forwarding (in this case, readdressing) is performed by the sender rather than an external agent.

This invention is also different from a service that operates in a direct forwarding mode like the examples cited above in the discussion of the prior art. With direct forwarding, a sender knows and uses an existing address (not an alias incorporating the address) for the intended recipient, and uses the customary communications channel (service) for the communication. The communication is received at the address (or intercepted upstream) and forwarded to the recipient's new or preferred address.

### SUMMARY OF THE INVENTION

The invention provides for indirect forwarding of communications (as defined below) from a sender to a recipient through the use of a forwarding service. The forwarding is implemented using an address which is known or believed to be temporarily or permanently invalid (the “old address”) as the alias (or a distinguishing component of the alias) to communicate with the recipient through a medium, including media other than that in which the address was formerly (but is not presently) valid. The invention enables and facilitates the transmission and reception of communications when the current correct destination of a communication to an intended recipient (e.g. street address, telephone number, e-mail address) is unknown to the sender, but a previous destination, not presently active for this recipient, is known. This method may be applied to electronic mail, telephony, postal mail, Internet Protocol (IP) telephony, Internet web pages, instant messaging, files, video transmissions, and other types of communications that require an addressed destination for the communication to be received. The communication may serve the purpose of conveying information in and of itself (as in a telephone call), or it may serve the purpose of enabling the transfer of information, as in establishing access to a file where the file is the information ultimately sought.

The means of forwarding is referred to herein as “indirect forwarding” because the communication is not directed to the known, old address as would normally be done if the address were operational, but through a separate server, herein called a “forwarding service”, and then on to another address. It will be understood that in this context, the term “separate server” means a service which is not the same as a communications service which would ordinarily be used to send the message from the sender to the recipient, but which might be owned by or a subsidiary part of an ordinary communications service, or might be an independent entity.

The sender (or an agent for the sender) using the invention sends the message to a specific, known interim destination (forwarding service) that is not associated with the original address, using an old address associated with the registrant as the basis for an aliased address. (It is not necessary for the addressee to have previously disclosed the intermediate address to the sender.) It is at the interim destination that the old address is matched to a specific forwarding address and the communication is redirected. (Note also that the sender need not know that the intended recipient is registered, although if she is not registered, the communication cannot be successfully forwarded by the service without obtaining her forwarding address some other way, such as culling and matching data from available external sources.)

In basic terms, the method of the invention works as follows: if a sender wants to forward a communication to a recipient whose present address is unknown, he directs the communication to a central service address for the forwarding service. The sender provides a previously active, but not presently functioning address belonging to the intended recipient. This information is looked up in a registration database linking previous addresses to forwarding addresses. The forwarding address is found and the forwarding service then redirects the communication to its final destination.

### BRIEF DESCRIPTION OF THE DRAWING

FIG. 1 shows a block diagram of an embodiment of the method of the invention

FIG. 2 shows a block diagram of another embodiment of the method of the invention, having forwarding to multiple media.

FIG. 3 shows a flowchart of the method of the invention

FIGS. 4A and 4B show a flowchart of another embodiment of the invention, for applications having dynamically-assigned addresses

FIG. 5 shows a database structure which might be used with the embodiment of FIGS. 4A-4B

FIG. 6 shows an alternate database structure which might be used with the embodiment of FIGS. 4A-4B

### DETAILED DESCRIPTION OF THE INVENTION

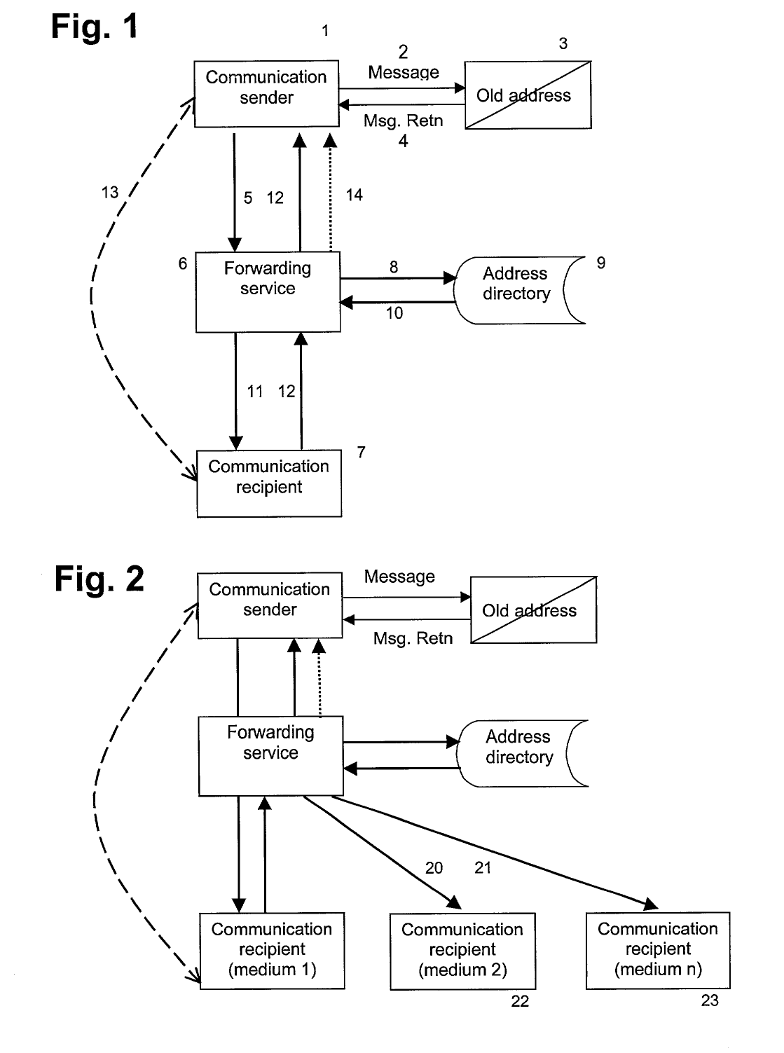

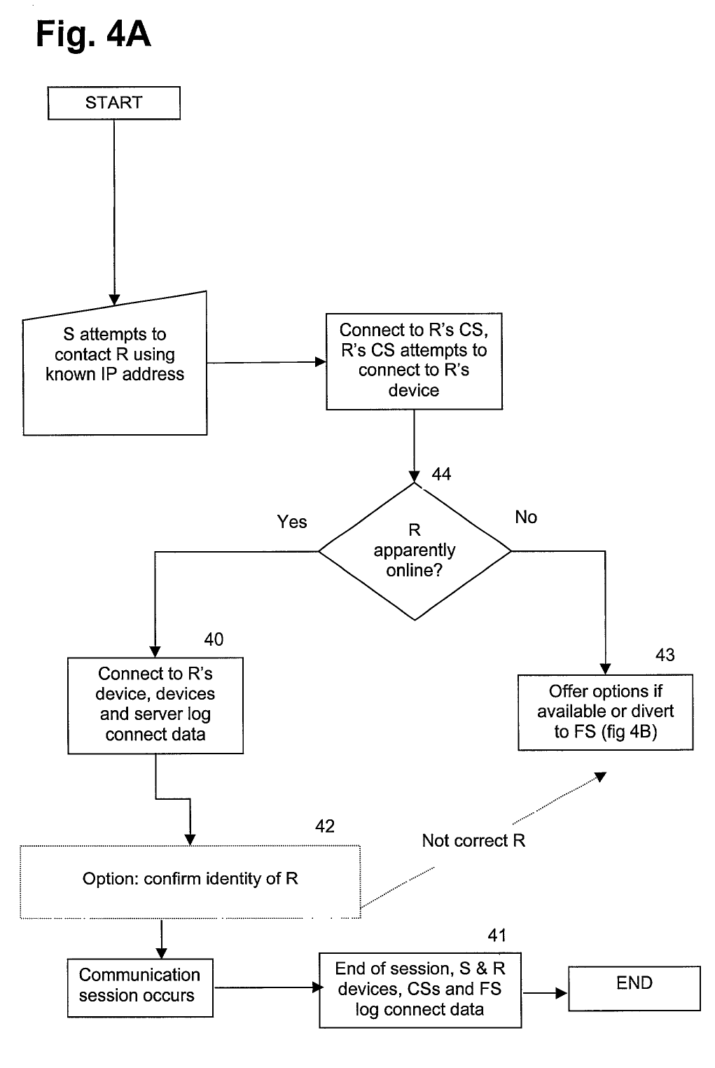

Referring to the block diagram of FIG. 1, and also the flowchart of FIG. 3, Sender 1 of communication in a particular medium (e.g. telephone, electronic mail, postal mail) attempts to contact intended recipient by sending a message 2 using known address 3. Recipient's former or non-operational communication service replies 4 with message saying the intended recipient's address is non-functioning, doesn't exist, the sender's message is blocked for lack of authorization, compatibility, or other reason, etc. (or there is no response from the recipient's communication service or recipient and the sender assumes there is a problem with the address or the service).

Sender 1 now attempts to contact recipient by sending the message 5 to forwarding service 6 (separate from standard communications channel provided by first communications service) where recipient may have registered his old address 3 and his current address 7 to which communications are to be forwarded. Forwarding service 6 looks up 8 old address 3 in the directory 9. If there is a corresponding new address, the new address is retrieved 10 from the directory 9, and the communication is forwarded 11 (connected) to the recipient. Recipient's response 12 to sender's communication 11 may take place via forwarding service 6 or via a separate direct path 13. (This may depend primarily on whether the medium of the communication is interactive (e.g. the telephone) or one-way (e.g. postal mail).)

Forwarding service 6 may also communicate a variety of messages 14 back to the sender, including non-registration of recipient, recipient's current address, etc. The separate direct path 13 may be enabled by communication of addresses from receiver to sender (or vice-versa) through the forwarding service channel or by the forwarding service supplying the address itself at the request of sender or receiver.

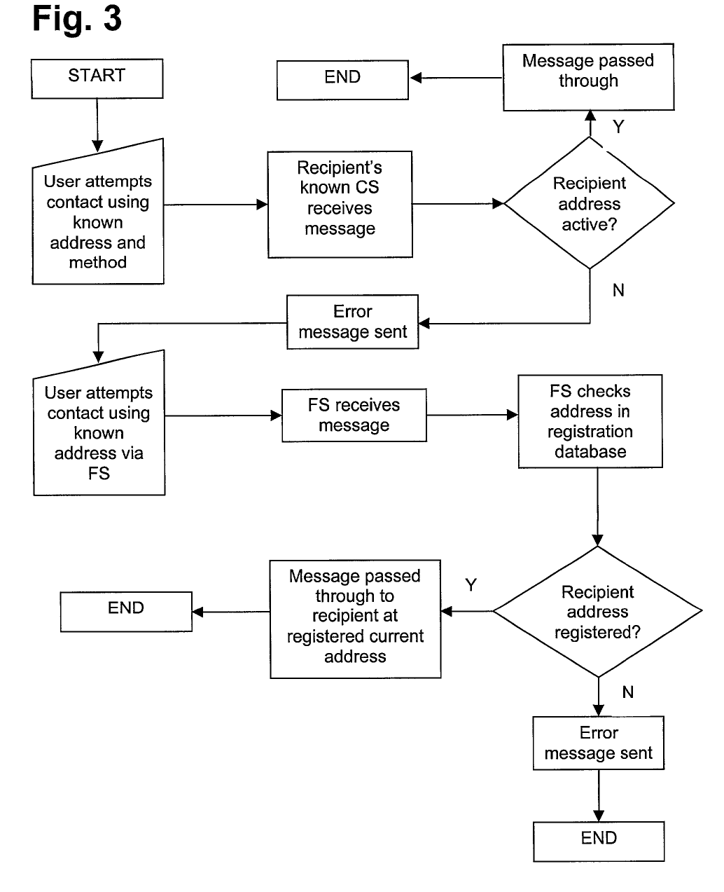

In a variation of the above, as shown in FIG. 2, sender of communication attempts to contact recipient using a forwarding service that operates in a medium different from the one to which the known non-working address is applicable. As an example, a non-working telephone number is used as a component of an e-mail address and sent with a communication 20 to an e-mail forwarding service 22. The communication is forwarded as an e-mail. Alternatively, or additionally, the communication 21 could be translated to electronic speech and forwarded to a telephone 23, to be delivered as a telephone message.

### Inclusion of Additional Information with Forwarded Communication

Using the method of the invention, additional information can easily be included with the forwarded communication. This information could convey, for example, information about the service, when the original communication was sent, when it was first returned to the sender, advertising, and invitations to action on the part of the recipient that may be carried out using the medium of the message or alternative media. The information can be forwarded to the recipient in different ways within the teaching of the invention, depending upon the mode of communication being used.

In postal mail, for example, the forwarded letter can be enclosed in a physical envelope along with flyers from the forwarding service, paid advertisements from sponsors, a postal service forwarding package, etc.

An original e-mail message transmitted through the forwarding service can be relayed as an attachment to a larger e-mail, the other section or sections of which function as an envelope or wrapper that may contain additional information. This envelope can also be transmitted in-line in an e-mail with the original message as an insertion.

The “envelope” could also incorporate button or text hyperlinks that perform specific functions related to the e-mail and to the service. These functions include: refusing messages from this sender in the future; refusing messages from this domain in the future (which may be useful in blocking “junk” e-mail); accepting messages only from this sender or domain in the future; sending the recipient's present address to this sender; canceling the forwarding service; recommending the service to another e-mail user (providing the prospective user's present e-mail address); enabling “junk” e-mail blocking measures. Functions may also be activated at the forwarding service itself, via a user's individual preferences page at the service's web site.

### The Forwarding Database

The indirect forwarding service contemplated herein generally relies upon registration by the prospective recipient of a communication. The minimum information a registrant would provide to the forwarding service is one data pair—an old address and a forwarding address (in this document described using the syntax old address:forwarding address). If desired, additional personal information may be collected to enable distinguishing two or more parties with the same old address, to sell advertising based on demographics, to select individuals and groups from which to block or allow transmission of messages, etc.

A single forwarding address could be paired with more than one old address (such as when several e-mail accounts forward separately to one address). However, each old address must either be unique in the forwarding database or have a key to distinguish it from a) other users of the same old address (e.g., different registrants using the same telephone number as an old address), b) other uses of the same old address with addresses in different communications media for the same user (e.g., street address vs. telephone number as the forwarding address), or c) other uses of the same old address for different addresses in the same medium for the same user (e.g., work vs. home street address as the forwarding address).

In case a), the key can be implemented by asking the registrant to supply an additional piece of identifying information, e.g. her name. This key can later be used by a message sender to distinguish between two or more registrants who may have signed up with the same old address. As an example, a person who wants to change telephone numbers might naturally register his old number along with his new number (his new “address”). In this case, if the person who previously had the old number were also registered and using this as his old address to forward telephone calls, there would be two data pairs with the same old address. (Each, however, would have a different associated forwarding number.) With the addition of the key, the call can be correctly routed. Either the key can be disclosed to the sender to allow him to choose among recipients or the sender can be asked to provide a key in a particular information class corresponding to his intended recipient. For example, the caller could be prompted to dial 1 for Jane or 2 for John or the caller could be asked to speak the first name of the person being called. With either method, the service could then select the appropriate recipient for the call and route it accordingly.

In case b), a registrant may link addresses in different media to a single old address. For example, if the old telephone number is used as the old address, it may be paired with both the new telephone number and the (possibly new) e-mail address. It is then used as the old address for forwarding by telephone or e-mail. A message may also be forwarded from one medium to another. As an example, a caller to a telephone forwarding service using the intended recipient's previous telephone number as the old address may be prompted to choose between talking directly to the recipient via telephone or recording a message to be sent electronically via e-mail as an attachment.

In case c), a registrant of the service may wish to allow the message sender to choose from among two or more addresses in the same medium, e.g., work and home e-mail. To do so, the key would be conveyed to the sender to allow her to choose.

In addition to information derived from recipients directly, the forwarding service can search external address directory databases for updated addresses (either manually or automatically via a software program). The intended recipient could be notified that there is a message waiting for them and encouraged to register in order to receive it, or the database could be automatically updated without registration. Suitable security features would be necessary to minimize the possibility of mail going to an unintended recipient, both here and in the more general case where a recipient registers himself. One such feature is to encourage senders to send a test message to confirm the identity of the recipient before transmitting any sensitive information.

The registrant could be required to preregister the old address while the soon-to-be invalid address is still functioning. This allows for verified approval of the registering current address owner as well as convenience for the registrant. It also allows for verification of previous ownership to a prospective sender, if the information is chosen to be published.

The registrant could be allowed to set passwords to sender's choice of communication medium or address for forwarding (e.g. private e-mail or emergency telephone number with password), and could also be allowed to set conditions on available communication types, e.g. based on time communication is sent or on sender-provided information.

A notification of the new forwarding address could be sent to a contact list submitted by registrant with his registration. In that case, any future change could also be sent to them automatically. The recipients of the new address could also be invited to register themselves and have their future changes sent to registrant. In addition to case-by-case selection, an approved senders and domains list can be input by registrant, so that only certain communications would be accepted for forwarding, or alternatively a list of disapproved individuals and groups can be specified in order to reject their communications before forwarding.

Registration and updating can also occur in an automated manner. For example, a telephone could be programmed to periodically dial a telephone-based forwarding service, publish its present assigned telephone number through Caller ID or by playing back tones representing the number as previously input to the telephone by the user, and also play back tones representing the previously assigned number. The database then updates or adds to the old address:new address pair. In e-mail, the same process could be carried out by software in an automated fashion. The address could be published automatically by a software agent to a central database as soon as it changes, along with the previous address. Similar extensions in these and other media can be made to a semi-automated or manual updating mode. Taken together, these additional methods enable other ways of updating the forwarding service database so that a communication sender can reach the recipient.

### Examples of Data Pairs

The most natural old address to use is the one that corresponds to the previous address in that particular medium. This address is then registered with the new address in that medium to provide the data pair—for example, old telephone number:new telephone number. However, the old address need not be limited to an address in the same medium as the new addresses, as discussed herein.

| Old address | Forwarding address |
|---|---|
| 2123251122 (old telephone number) | 1-212-327-2237 (new telephone number) |
| 2123251122 (old telephone number) | jane@aol.com (current e-mail address) |
| jane@oldco.com (invalid e-mail address) | jane@aol.com (current e-mail address) |
| jane@oldco.com (invalid e-mail address) | Jane Doe (current postal address) |
| | 16 Morningside Lane |
| | Hertown, NJ 07733 |

It is worth noting that this invention may also be useful in situations where the known, existing address is normally still valid but temporarily not operational. If the intended recipient has registered a backup address with the indirect forwarding service, a message can be sent to him using the same techniques described above.

### Chained Forwarding

When a user, for example, sends an e-mail to a bad address and then forwards it using the forwarding service, if the address to which it is forwarded is invalid, either he or the service repeats the process with the forwarded address now being the invalid address. The message is sent through the forwarding service for processing as if it were a new communication. This can be within or across media.

### Cascading Forwarding

When a user, for example, sends an e-mail to a bad address and forwards it using the forwarding service, the recipient has a registered list of forwarding addresses that may be prioritized and may rely on the forwarding service to convert to a different format or medium. The communication, for instance, is first forwarded as an e-mail. If the communication cannot be delivered to the recipient, the forwarding service sends the communication to the next forwarding address on the recipient's list. If this is a telephone number, the text of the message is converted to speech and the telephone number is dialed. The message is then delivered. If it cannot be delivered, the process can be continued until the list of addresses or the conversion capabilities of the forwarding service are exhausted.

### Multiple Forwarding

A recipient may wish to receive forwarded messages at a number of addresses, more or less simultaneously. A sender would send an e-mail to the forwarding service using one of the previously disclosed methods. This could be forwarded on to two or more of the recipient's addresses, for example, to an e-mail address and to a postal address (after printing (“the conversion process”)). These options might also be available only on the submission of a password, such as to differentiate for forwarding to public and private e-mail boxes.

### Examples of Applications of the Method of the Invention

The method can be used with many communications media, as are detailed below. In addition. other media, such as video phones (switched, over cable or over IP), faxes, teletypes, telexes, pagers, personal digital assistants, cellphones, cable terminals, direct broadcast terminals, or online chat venues or other methods now available or yet to be developed, can be used within the teachings of the invention.

### Application to Electronic Mail

Electronic mail (e-mail) has become an important method of communication. To send an e-mail, the sender normally composes the text of a message on a computer or other device using an application program, often one called an e-mail client. The sender addresses the message by inputting an e-mail address corresponding to the known e-mail box of the intended recipient. The e-mail is then sent to the recipient. It travels electronically through established protocols, often via the Internet, until it reaches an e-mail server at its destination and is indexed to the correct mailbox for pickup by the recipient.

E-mail addresses are not necessarily permanent and may be changed or deleted by the addressee or the addressee's service provider for a variety of reasons. The addressee may notify her correspondents that her address is changing or has changed and the service provider may also do this for the addressee.

When the sender of an e-mail has not been notified of an address change, there are several ways he may find out or conclude that the original address is no longer valid. He may have been informed that the recipient has changed jobs or Internet Service Providers (ISPs); he may have found out in some other way that the previous address is no longer valid. Alternatively, an e-mail he sent may have been returned as undeliverable; a notice of undeliverability may have been received without the original e-mail being returned; or there may have been no response to an e-mail that was sent and the sender may interpret this as a problem with the service or address.

Methods of Operation

There are several related methods of facilitating the receipt of the e-mail when the intended recipient's current address is unknown to the sender. All of the practical automated methods rely upon an old address:forwarding address database. Often the data pair will consist of the recipient's previous and current e-mail addresses. The methods rely on the data pair being provided by the prospective recipient in a registration process or the information being provided in some other analogous way, such as by a third party with access to the relevant data.

Method 1 (Original e-mail returned)

The first method is: when an e-mail is sent to the recipient's old address and returned to the sender, the sender forwards the returned e-mail (as is, unmodified, with the accompanying notice of undeliverability) via e-mail to a mailbox at the forwarding service's e-mail server (e.g., to find@thrumail.com).

The e-mail is processed at the forwarding service (FS) by a data extraction program. The program extracts the message content of the original e-mail and the intended recipient's old address. It then checks the database of forwarding addresses for the new address (using the old address to find it) and sends the e-mail to the intended recipient at her current address (ordinarily using e-mail server software). The e-mail server or other software may also notify the e-mail's sender of the action that has been taken, and if desired, the recipient's new address.

Method 2 (Notice of undeliverability returned without original e-mail)

In the case in which the original e-mail is not returned to the sender, but a notice of undeliverability is, the original e-mail can be resent if it still exists in the sender's files. The e-mail remains addressed to the recipient (as before) and a copy is sent to find@thrumail.com (the forwarding service address). This can be done in a To: or cc: box or by another similar way of addressing an additional recipient, or by resending using the “forward” e-mail function which revives the e-mail and then requires readdressing to find@thrumail.com. The e-mail is then received at the forwarding service and processed as in Method 1. Additionally, the e-mail could be addressed to multiple recipients and the forwarding service would attempt to deliver the message to each addressee. In this case it is desirable for the sender to remove those addresses at which the message was believed to have been properly received on its first transmission.

Method 3 (Aliased address)

Alternatively, the sender can address the e-mail directly to an aliased mailbox at the forwarding service, using a simple heuristic to derive the recipient's mailbox address from the previously known address. Once sent to the forwarding service, the e-mail can be forwarded immediately by the forwarding service's e-mail server (using existing functionality) to the intended recipient at her present address (assuming the addressee has registered her present address with the forwarding service). (The message could also be stored for later retrieval.) In this manner, a sender could easily derive a recipient's mailbox address at the forwarding service, and thus a link to the present, unknown final address, by a simple modification to the previous, non-working address.

As an example, to send a message to Jane Doe, whose former known address was jane@bigcorp.com, the sender addresses an e-mail directly to her at her aliased mailbox at the forwarding service, jane-bigcorp.com@thrumail.com. (Here a “-” (or other non-meaningful but syntactically valid character) is substituted for the “@” in the original address to enable the transmission to bypass delivery to the original address (the “@” can also simply be dropped, but this may ultimately lead to aliases that cannot be properly parsed back to the original address)). The sender then sends the e-mail. Once the alias is parsed and the forwarding address found in the database, the e-mail is relayed by the forwarding service directly to the registered forwarding address.

If the e-mail is accompanied by an “undeliverable” message or other information extraneous to the original message and has been sent to the aliased address, the forwarding service can extract the original e-mail. As before, it can then be forwarded to the recipient based on the registered forwarding address. Again, the sender may be notified of action taken or other information.

Method 4 (Web-based message input form)

Another method is to create a message in a data form on the forwarding service web site, addressing it to the previous known address. The web site looks up the user's new address, then takes the text and composes it into a message formatted as e-mail and suitable for transmission via e-mail protocols.

Method 5 (Direct e-mail pass-along)

An e-mail sent to a non-functional address, rather than being rejected by the service provider at the domain of the non-functional address and bounced back to the sender, may instead be bounced to the forwarding service (e.g. to find@thrumail.com) for final disposition. There it could be processed as in Method 1 above.

Method 6 (E-mail client methods)

Another method relies on the automation capability of e-mail client applications (or a free-standing software program that can interface with the e-mail client). The sender's e-mail client could be configured to interrogate the forwarding service using the old address when an e-mail is returned as undeliverable (or it could check to see if the address is no longer valid by interrogating the forwarding service before sending the e-mail). The response to the e-mail client could be in one of three forms: 1) the current address is unknown; 2) the current address is in the database, but is not available for disclosure; 3) the current address is jane@newco.com. In the case of response 2), the e-mail client could then resend the e-mail to the forwarding service using Method 1, 2, or 3 above. In the case of response 3), either the user could manually readdress the e-mail or the e-mail client could automatically readdress it for sending manually or automatically.

Alternatively, rather than interrogate the forwarding service, the e-mail client could simply forward an undeliverable e-mail without checking by using Method 1, 2, or 3.

Method 7 (Central or local registry)

Another method is to store an address pair database 1) on a central network like the Internet or 2) on a local server (with a copy of the database that is periodically updated) to automatically route e-mail to the recipient's current preferred address. In addition to allowing for forwarding when the address known to the sender is no longer valid, such a system would also enable the use of a preferred forwarding address even if the address known to the sender is still valid. Three general options are possible as each e-mail is sent: 1) the sending e-mail server could send every e-mail to the forwarding service database server which then acts as a router and directly transmits the e-mail to the mailbox corresponding to the recipient's current or preferred address (passing it through if the recipient is unregistered); 2) the sending e-mail server could interrogate the central or local database to verify that the address to which the e-mail is being sent is the current or preferred one; 3) any intermediate server or a receiving server at the address originally entered in the e-mail could perform 1) or 2). The verifying e-mail client or server could then automatically change the e-mail's address (if necessary) and send it on, it could add the new address as an additional recipient of the e-mail and send it on, or it could report back to the sender to allow him to decide what to do.

Method 8 (Combination of above methods)

Combinations of elements of the above methods also exist and these may be used to provide the intended services.

In order to prevent the forwarding service from becoming a source of junk e-mail or “spam”, generalized “spam” discouraging or blocking methods may be applied including: registering senders before accepting e-mail from them for forwarding; and blocking messages originating from a given address or domain when the number of messages forwarded through the forwarding service in a given time period exceeds a predetermined level.

### Application to Postal Mail Forwarding

The method can be applied to other media, including those that are not electronic. For example, suppose a sender has sent a letter to Jane Doe at Jane's last known address, and the postal service has returned the letter because the recipient has not left a forwarding address, the forwarding order has expired, or some other reason. The sender seeking to have a letter forwarded could send it to the forwarding service at its postal address, using the original address as an alias:

Jane Doe/41 Creamery Road/RichfordN.Y. (the old address)

Thrumail, Inc. (the forwarding service)

123 Postal Drive (the postal address of the forwarding service)

Washington, D.C. 20001

If Jane has registered with the Thrumail forwarding service, that service will then forward the letter, perhaps in an envelope enclosing or incorporating advertising material or other information, to Jane's new address. The letter reenters the mailstream addressed to the associated forwarding address:

### Jane Doe

### 16 Morningside Lane

### Hertown, N.J. 07733

As an option, the service can also send a postcard or envelope with advertising back to the sender, advising her of the new address.

The original, presently non-working, address need not belong to the same medium as the message. For example, instead of using Jane's old postal address, the sender could send the letter to the forwarding service with her old telephone number (now disconnected) as the alias, as follows:

12123251122 (the old address (Jane Doe's old telephone number))

Thrumail, Inc. (the forwarding service)

123 Postal Drive (the postal address of the forwarding service)

Washington, D.C. 20001

At Thrumail, the alias (old address) 12123251122 is checked to see if it is in the database (along with variants like 1-212-325-1122) and if it is, the letter is sent to the forwarding address associated with the old address, perhaps inside a mailer with advertising, as discussed above.

Alternatively, the original postal mail, containing the old address, can be enclosed in a new envelope addressed to the forwarding service. At the forwarding service, the original mail is extracted, the old address read from the original envelope, and the forwarding proceeds as described above.

The operation of the forwarding service differs from general “care of” addressing in several ways. First, in standard “care of” addressing, it is not normally intended that the letter be forwarded but that it be received by the “care of” party on behalf of the recipient. Second, the letter is ordinarily addressed by the recipient's name and the service is provided for one or a limited number of users. Third, the previous address is not relevant to the handling of the letter. Fourth, “care of” addressing differs from indirect forwarding in that the address has been given to the sender by the recipient as a substitute for a standard address, and the recipient in providing it and the sender in using it believe it to be a valid address for the communication to reach the recipient.

### Application to Telephony

For a simple telephone-to-telephone communication, the application of the invention is straightforward. A person wanting to reach someone whose present telephone number is unknown would dial in by telephone to a known forwarding service (viz. 1-800-FORWARD (1-800-367-9273)). The caller would then be prompted to enter the known, previous telephone number (that is not presently operational for the person being sought). The service would then dial the registered forwarding number and connect the caller to the person she is trying to reach.

Other possible features include: 1) as a security device, after entering the registrant's previous telephone number, the caller could also be prompted to supply a key, e.g. the first name of the registrant or the name of the registrant's dog; 2) instead of having the service dial the new number, the caller could choose to send a message using another medium, e.g., an alphanumeric or sound message sent by e-mail but entered by means of the telephone; or 3) the registrant may elect to pay for forwarded calls herself or have the caller pay.

The same method can be used for an additional telephone application, namely voice over IP. A caller dials into Thrumail, speaks or otherwise enters the previous IP phone number or address of the person he is calling, and is connected to the person's computer or other internet-enabled device to complete an IP telephone call.

### Application to URL Forwarding

A dead or temporarily out-of-commission URL is http://www.oldURL.com. For a user to find where it is now (or a mirror site of the out-of-commission one), they would type into their browser http://www.thrumail.com/www.oldURL.com (assuming the owner of oldURL.com has registered). Upon reaching the forwarding website, the browser would be redirected automatically to http://www.newURL.com (or the user could click on a link or be given the link in text, etc.). This forwarding could be also be accomplished using an old address in a different medium, such as http://www.thrumail.com/6177554327 where 6177554327 represents the previous main telephone number of the company. The forwarding alias may take other forms as long as they are syntactically permissible, e.g. http://6177554327.thrumail.com or http://www.oldurl.com.thrumail.com.

As another example, a personal web page can be reached using the person's old e-mail address, viz. http://www.thrumail.com/adam-aol.com.

### Application to Instant Message Forwarding

Suppose, for example, a user has the identification label “Adam” in AOL's Instant Messenger(tm) service. Adam leaves AOL and signs up for the MSN(tm) instant messaging service. Someone seeking to communicate with Adam who only knows his old address on AOL Instant Messenger(tm) would enter AOL-Adam (the intended recipient of the communication) into a Thrumail-provided instant messaging interface (or directly onto MSN if the seeker thinks there's a good chance he's there) which would then patch the communication through to Adam's new registered address on MSN.

### Application to Dynamic Address Tracking

In some situations, e.g. in an environment where addresses are dynamically assigned and the physical address for a user or device may change relatively frequently, it may be desirable to have the forwarding service track previous addresses and match them with the current one to forward communications. (Tracking could also be done by a local network server, by a communications server, for example, in the case of an Internet connection, by the web server at a target website using the information available from the user's browser, or by the Internet service provider assigning the address. This may be a way to substitute for “cookies” when the target website is tracking IP addresses and may alleviate current privacy concerns.) This mechanism may also be used to track the (approximate) physical location of a user by looking up the geographical location of the IP or other address (if available in a database).

As an example, a caller has a voice over IP conversation with a recipient, such as a service representative at a web-based help desk. The recipient (or the communication reception station, e.g. a personal computer) has a dynamically assigned IP address (or addresses) for the duration of the conversation and possibly longer. The IP address of the recipient or station and the time and duration of communication and/or IP assignment are recorded in a database. At the next connection of the recipient (from a new IP address or the same one as previously), the new current and previous IP addresses are published to the forwarding service database and matched to the previous IP address and time period. A caller seeking the recipient of the previous communication knowing only a previous IP address and time period can now be connected to the correct station through forwarding, i.e. an old address:new address pair exists. Note that the caller need not necessarily personally know the old address; this function may be performed by a software interface or connected database.

The publishing of the recipient's IP address and time information can be accomplished in three basic ways: manually, where the user goes to a database, e.g. on the web, and inputs this information himself; semi-automatically, where the user pushes a button which connects to the database and publishes the information; and automatically, where a software program publishes the information to the database as a background task periodically or on the occurrence of a particular event, e.g. the initiation or conclusion of a call. Note also that the originator of the communication may also be tracked using the same method and this allows the recipient of the communication to contact the originator again.

Another method to reinitiate a previous communication is for the caller to provide his IP address and time slot (manually, semi-automatically, or automatically) from his previous call and have the database perform the additional step of translating this previous address of the caller to the previous address and time slot of the recipient which is then translated to the current address of the recipient (of course the database must now also log the caller's information as well as the recipient's and connect the two).

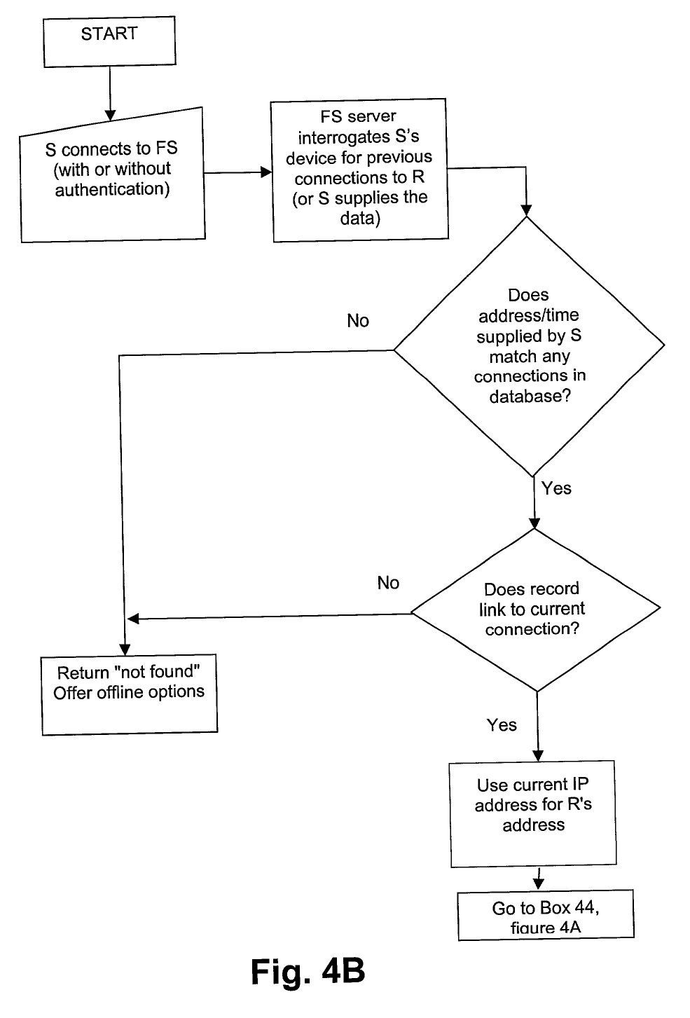

FIGS. 4A and 4B show a flowchart of this application of the invention. This case assumes S (sender) and R (recipient) are on different communications services (CS, in the flowchart), and the forwarding server (FS, in the flowchart) is a separate system from one or both of the communications services being used by S and R. If S and R are on the same service, there might still be a completely separate forwarding server, but more likely a subsystem of the communications server or an associated computer on the same network would act as the forwarding server.

Starting with FIG. 4A, S initiates contact with R by attempting to contact R using the known address. S connects via S's communications service (CS) to R's communications service, and R's CS attempts to connect to R using the address supplied. If R is apparently online at R's CS at R's known address, then the connection is made, and R and R's CS log the data (time, address) for the connection on the FS (S and S's CS may also log the time and address, so the system can work both ways). At this point, S, S's CS, or R's CS might verify that the IP address reached is, in fact, R, by any convenient means—querying the user or the user's device for an identification, notifying the user about the impending connection, etc. If the connection no longer points to the desired R, then the flowchart proceeds as if the connection could not be made. Otherwise, the communications session occurs, then ends and the users and CSs log the ending data.

If, on the other hand, no user matching the address supplied by S is online, then either R is not connected or R may have been assigned another dynamic address. R's CS can either accept or record a message to be delivered to R, notify S to connect to the forwarding service himself, or divert the connection request to the forwarding service.

In FIG. 4B, S has received the notice that the IP address he has used to connect to R is not currently valid. S connects to the FS (either by logging in as a user, or anonymously). The FS can interrogate S's device to get the address and time of last connection with R (if this information had previously been stored on S's system, as by a “cookie” or other file), or S can be prompted to provide the address and connection time (this can be any time during the period of the connection). It will be understood by one skilled in the art that in this context “time” can include “date”, and an implementation of the method might choose not to include the date, or might use a serial time (seconds since Jan. 1, 2000, for example) within the teachings of the invention.

The FS looks the address/time pair up in its database to find an entry for that IP address logged on at that time. If an entry is found, then the FS looks to see if there is a current connection associated with that entry. If there is, the FS attempts to connect the communication from S to R via R's CS, or returns the new address for the connection (box 44 of FIG. 4A). If no current entry is found at the FS, then S is informed and perhaps additional options might be presented.

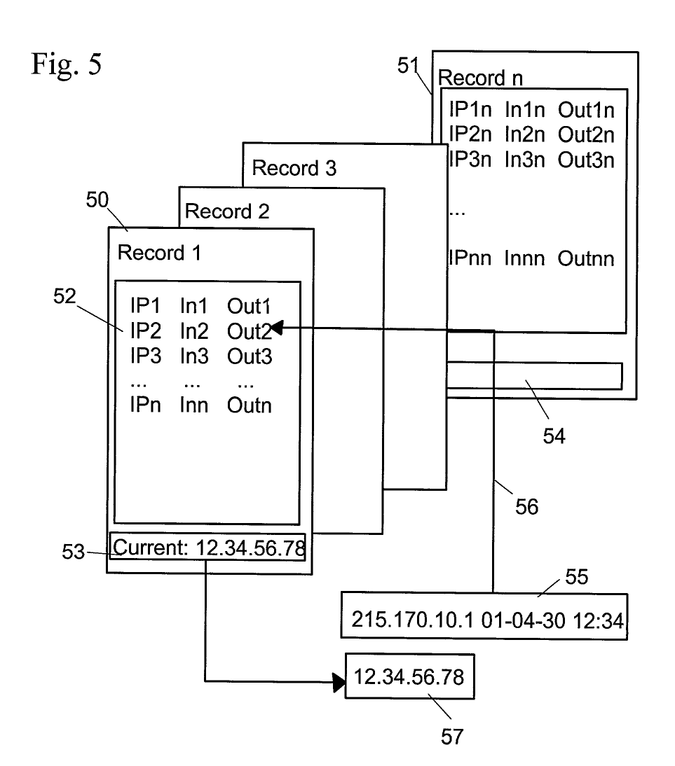

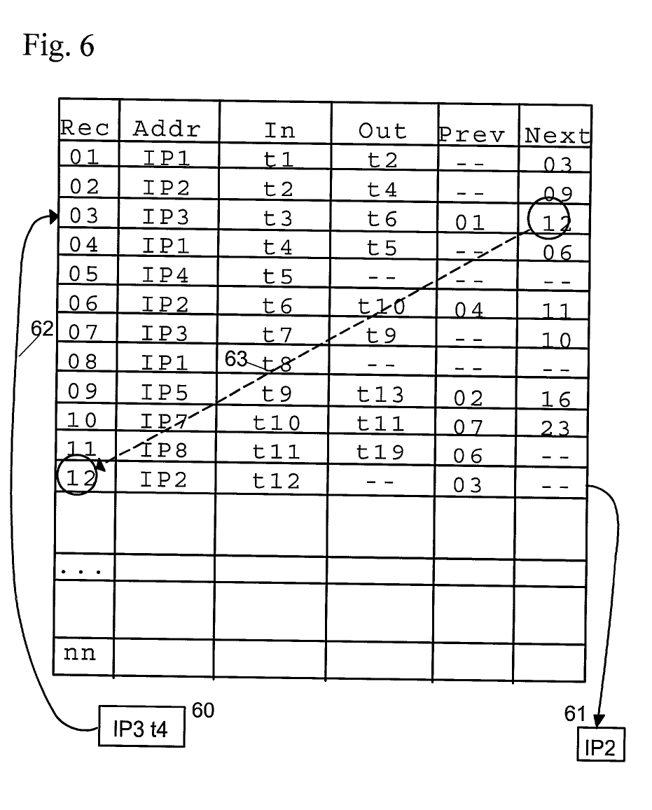

FIGS. 5 and 6 show several ways the database of this embodiment of the invention might be organized.

In FIG. 5, the database is made up of a number of records, one for each distinct user or string of connections. Each record contains a list of connection addresses and times for that user, and a current connection address, as appropriate. At each subsequent connection of the user to the database, the user or user's device supplies information identifying the previous connection (or any connection in the user's record) and the current connection. The previous IP address and time is found to match IPn-1, Inn-1, and Outn-1, and the current connection information is appended to the user's record. As shown in the figure, record 50 has a list of “n” connections 52, and this user is currently connected to IP address 12.34.56.78. The user of record 51, however, is not currently connected, so his current connection field 54 is blank (or there could be a “connection closed” flag, a log out time, or some other indicator). Suppose S sends a forwarding inquiry 55, looking for the user who he had connected to at IP address 215.170.10.1 at 12:34 PM on Apr. 30, 2001. This links to line 2 in the list 52 of record 50 (the IP address matches IP2 and the time falls between In2 and Out2), so the forwarding system would return the current IP address of 12.34.56.78 (or select the last item on the time-sorted list if the item has no associated termination time, if appropriate).

FIG. 6 shows an alternate arrangement of the database, as a linked list. Each record contains an IP address, a time logged in and a time logged out, and a pointer to the next record and/or the previous record in the linked list. As each user connects, his IP address and time in are added to the list. At the same time, the user gives his last connection time to the forwarding system and the record for that connection is updated to point at the new connection (alternatively, or in addition, the new record could point back at the last connection, in a doubly-linked list). Using this embodiment, suppose S sends a forwarding inquiry 60, looking for the user he had connected to at IP address IP3 at time t4. The FS looks down the list, and finds 62 on record 03 that IP3 was connected between t3 and t6. Record 03 has a forward link 63 to record 12, which shows an IP address of IP2, a log in time of t12 and no log out time—therefore the user is currently logged in at address IP2, and the forwarding system returns a new address 61 of IP2.

It will be understood by one skilled in the art that these are just examples, and other database structures are possible within the teachings of the invention.

As an example, to share files in a network, a file-containing device might log on using a dynamically-assigned address and deposit a file directory with a central server where it is stored in a database. The connection is then terminated, perhaps by the device itself or perhaps by the server in order to use bandwidth efficiently. Another device may then query the central server and seek a file located on the first device, whose previous address and time of assignment is stored in a database.

The server then checks if the device is currently connected and if so connects the two devices. If the first device is not currently logged on but is capable of being queried by the server and establishing a connection, the server can poll the unconnected devices capable of responding and establish a new connection with the first device. How does it know which device is the one that was previously connected? The device itself can also store its previous connection information and a match can then be made to the forwarding information on the central database. This method may be especially valuable in an anonymous environment where users are not required to log in (somewhat analogous to placing a telephone from a public payphone).

### Application to Computer Files

As an example, Napster(tm)-based music files are located on many different computers with a central server or servers acting as a global directory. If the title of a file changes and a user cannot locate it with the Napster application using the previous title, the request may be passed or redirected to a forwarding server that can process the request and connect to the newly-titled file using the described technology (assuming that the address change has been registered by one of the disclosed methods).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of indirectly forwarding a communication from a sender to a recipient where an old address for the recipient is known or believed to be temporarily or permanently invalid, by sending the communication to a forwarding service at an address different from that of the recipient, comprising, at the forwarding service, the steps of:
a) receiving the communication;
b) looking up at least the old address in a database;
c) retrieving at least one second address from the database, which second address is associated with the old address;
d) sending the communication to the second address.

2. The method of claim 1, in which the old address is sent to the forwarding service as part of the forwarding address.

3. The method of claim 1, in which the old address is a part of the communication, and further comprising the step, after step a, of extracting the old address from the communication.

4. The method of claim 1 in which the old address for the recipient is selected from a group comprising: a telephone number, an e-mail address, a postal address, a uniform resource locator, an IP address, an IP address plus at least one time and/or date and/or duration, a file name, a file name plus a location, an instant messaging ID, a pager ID, a personal digital assistant ID, a cellphone ID, a cable terminal ID, a direct broadcast terminal ID, a telex number, a teletype number, and an online chat user ID.

5. The method of claim 1 in which the second address is selected from a group comprising: a telephone number, an e-mail address, a postal address, a uniform resource locator, an IP address, a file name, a file name plus a location, an instant messaging ID, a pager ID, a personal digital assistant ID, a cellphone ID, a cable terminal ID, a direct broadcast terminal ID, a telex number, a teletype number, and an online chat user ID.

6. The method of claim 1, in which the communication is selected from a group comprising telephone calls, electronic mail messages, postal mail, instant messaging communications, internet protocol communications, web pages, computer file transfer protocols, video transmissions, paging transmissions, personal digital assistant transmissions, cellphone transmissions, cable transmissions, direct broadcast transmissions, telex and teletype communications, and online chat transmissions.

7. The method of claim 1, in which there are more than one second address in the database associated with the old address, and the retrieval step c further comprises the step of selecting one of the new addresses based on selection criteria.

8. The method of claim 7, in which the selection criteria comprises a password supplied by the sender.

9. The method of claim 7, in which the selection criteria comprises a time of day.

10. The method of claim 7, in which the selection criteria comprises a priority ranking supplied by the recipient, and the second address returned is a second address having the highest priority.

11. The method of claim 10, if a second address returned in step c is invalid, further comprising the step of repeating step d with a next-higher priority second address until a valid second address is found or all second addresses are returned.

12. The method of claim 1, in which there is more than one second address associated with the old address, and step d is performed for more than one of the second addresses associated with the old address.

13. The method of claim 1, further comprising the steps of:
if there is a password in the database associated with the new address, prior to forwarding the communication requesting a password from the sender;
receiving a password supplied by the sender;
comparing the password supplied by the sender to the password in the database; and
only performing the sending step d if the comparison is successful.

14. The method of claim 1, if more than one second address is associated with the old address, further comprising the steps, after step c, of:
sending a communication to the sender with identifying material associated with the more than one second addresses retrieved in step c and requesting the sender to choose from among the more than one second addresses;
accepting a choice from the sender selecting at least one of the more than one second addresses;
sending the communication to the selected at least one of the more than one second addresses.

15. The method of claim 1, in which the at least one second address was registered by the recipient.

16. The method of claim 15, in which the recipient periodically updates the at least one second address.

17. The method of claim 16, in which the periodic updating is done automatically.

18. The method of claim 15, in which, in addition to registering at least one second address, the recipient specifies at least one sender from whom the recipient does not wish to receive communications, and the sending step d of the method further comprises the step of not sending communications to the at least one sender specified by the recipient.

19. The method of claim 15, in which, in addition to registering at least one second address, the recipient specifies at least one sender from whom the recipient wishes to receive communications, and the sending step d of the method further comprises the step of sending communications only from the at least one sender specified by the recipient.

20. The method of claim 1, in which the at least one second address was retrieved by the forwarding service from a source other than the recipient.

21. The method of claim 1, in which the forwarding step (d) further comprises the step of including additional information in the communication.

22. The method of claim 21, in which at least some of the additional information is advertising.

23. The method of claim 1, further comprising the step of sending a confirming communication back to the sender.

24. The method of claim 23, in which the confirming communication comprises at least the second address to which the communication was forwarded.

25. The method of claim 23, in which the confirming communication also comprises additional information at least in the form of advertising.

26. The method of claim 1, in which the old address and at least one second address are addresses in the same medium of communications.

27. The method of claim 1, in which the old address and at least one second address are addresses in different media of communications.

28. The method of claim 1, further comprising the steps of:
counting the number of communications forwarded for a sender in a selected time period; and
not forwarding communications if the sender sends more communications to be forwarded during the selected time period than a selected limit.

29. The method of claim 1, if the second address retrieved in step c is invalid, of using the second address as an old address, and repeating the method from step b.

30. The method of claim 1, in which the communication is sent to the forwarding service by a server to which the communication was sent by the sender.

31. The method of claim 30, in which the server is associated with the sender, and the mail server automatically sends the communication to the forwarding service when the communication is returned as undeliverable.

32. The method of claim 30, in which the server is a mail server associated with the old address associated with the recipient, and the mail server automatically sends the communication to the forwarding service when the mail server cannot deliver the communication to the old address.

33. A method of sending a communication to a recipient when an old address for the recipient is known or believed to be temporarily or permanently invalid, comprising the step of sending the communication to a forwarding service at an address different from that of the recipient.

34. The method of claim 33 in which the old address for the recipient is selected from a group comprising: a telephone number, an e-mail address, a postal address, a uniform resource locator, an IP address, an IP address plus at least one time and/or date and/or duration, a file name, a file name plus a location, an instant messaging ID, a pager ID, a personal digital assistant ID, a cellphone ID, a cable terminal ID, a direct broadcast terminal ID, a telex number, a teletype number, and an online chat user ID.

35. The method of claim 33, in which the old address is sent to the forwarding service as part of the forwarding address.

36. The method of claim 33, further comprising the steps of:
a) the forwarding service receiving the communication;
b) the forwarding service looking up at least the old address in a database;
c) the forwarding service retrieving at least one second address from the database, which second address is associated with the old address;
d) the forwarding service sending the communication to the second address.

37. The method of claim 36, in which the old address is a part of the communication, and further comprising the step, after step a, of the forwarding service extracting the old address from the communication.

38. The method of claim 36 in which the second address is selected from a group comprising: a telephone number, an e-mail address, a postal address, a uniform resource locator, an IP address, a file name, a file name plus a location, an instant messaging ID, a pager ID, a personal digital assistant ID, a cellphone ID, a cable terminal ID, a direct broadcast terminal ID, a telex number, a teletype number, and an online chat user ID.

39. The method of claim 36, in which the communication is selected from a group comprising telephone calls, electronic mail messages, postal mail, instant messaging communications, internet protocol communications, web pages, computer file transfer protocols, video transmissions, paging transmissions, personal digital assistant transmissions, cellphone transmissions, cable transmissions, direct broadcast transmissions, telex and teletype communications, and online chat transmissions.

40. The method of claim 36, in which there are more than one second address in the database associated with the old address, and the retrieval step c further comprises the step of selecting one of the new addresses based on selection criteria.

41. The method of claim 40, in which the selection criteria comprises a password supplied by the sender.

42. The method of claim 40, in which the selection criteria comprises a time of day.

43. The method of claim 40, in which the selection criteria comprises a priority ranking supplied by the recipient, and the second address returned is a second address having the highest priority.

44. The method of claim 43, if a second address returned in step c is invalid, further comprising the step of repeating step d with a next-higher priority second address until a valid second address is found or all second addresses are returned.

45. The method of claim 36, in which there is more than one second address associated with the old address, and step d is performed for more than one of the second addresses associated with the old address.

46. The method of claim 36, further comprising the steps of:
if there is a password in the database associated with the new address, prior to forwarding the communication requesting a password from the sender;
receiving a password supplied by the sender;
comparing the password supplied by the sender to the password in the database; and
only performing the sending step d if the comparison is successful.

47. The method of claim 36, if more than one second address is associated with the old address, further comprising the steps, after step c, of:
sending a communication to the sender with identifying material associated with the more than one second addresses retrieved in step c and requesting the sender to choose from among the more than one second addresses;
accepting a choice from the sender selecting at least one of the more than one second addresses;
sending the communication to the selected at least one of the more than one second addresses.

48. The method of claim 36, in which the at least one second address was registered by the recipient.

49. The method of claim 48, in which the recipient periodically updates the at least one second address.

50. The method of claim 49, in which the periodic updating is done automatically.

51. The method of claim 48, in which, in addition to registering at least one second address, the recipient specifies at least one sender from whom the recipient does not wish to receive communications, and the sending step d of the method further comprises the step of not sending communications to the at least one sender specified by the recipient.

52. The method of claim 48, in which, in addition to registering at least one second address, the recipient specifies at least one sender from whom the recipient wishes to receive communications, and the sending step d of the method further comprises the step of sending communications only from the at least one sender specified by the recipient.

53. The method of claim 36, in which the at least one second address was retrieved by the forwarding service from a source other than the recipient.

54. The method of claim 36, in which the forwarding step (d) further comprises the step of including additional information in the communication.

55. The method of claim 54, in which at least some of the additional information is advertising.

56. The method of claim 36, further comprising the step of sending a confirming communication back to the sender.

57. The method of claim 56, in which the confirming communication comprises at least the second address to which the communication was forwarded.

58. The method of claim 56, in which the confirming communication also comprises additional information at least in the form of advertising.

59. The method of claim 36, in which the old address and at least one second address are addresses in the same medium of communications.

60. The method of claim 36, in which the old address and at least one second address are addresses in different media of communications.

61. The method of claim 36, further comprising the steps of:
counting the number of communications forwarded for a sender in a selected time period; and
not forwarding communications if the sender sends more communications to be forwarded during the selected time period than a selected limit.

62. The method of claim 36, if the second address retrieved in step c is invalid, of using the second address as an old address, and repeating the method from step b.

63. The method of claim 36, in which the communication is sent to the forwarding service by a server to which the communication was sent by the sender.

64. The method of claim 63, in which the server is associated with the sender, and the mail server automatically sends the communication to the forwarding service when the communication is returned as undeliverable.

65. The method of claim 63, in which the server is a mail server associated with the old address associated with the recipient, and the mail server automatically sends the communication to the forwarding service when the mail server cannot deliver the communication to the old address.

66. A method of forwarding communications from a sender to a recipient over a network where the recipient has an address which is dynamically assigned, comprising the steps of:
a) maintaining a database having a plurality of entries, each entry representing a session during which the recipient was connected and storing at least the address dynamically assigned while the recipient was connected and the time during which the recipient was connected using that address;
b) when a recipient connects, creating an entry in the database and linking the currently assigned address to an entry in the database for a previous connection;
c) accepting a forwarding request from a sender, comprising at least an address and a time representing a previous connection associated with the recipient;
d) using the address and time from step c, finding the entry in the database which represents the previous connection;
e) returning the currently assigned address for the recipient which was linked to the entry found in step d.

67. The method of claim 66, further comprising the step of:
f) connecting the communication to the recipient.
